(19) United States
(12) Patent Application Publication
(10) Pub. No.: US 2026/0081790 A1
(43) Pub. Date: Mar. 19, 2026

(54) METHOD AND SYSTEM FOR RECORDING DATA RELATING TO A TANGIBLE ASSET IN ASSOCIATION WITH A SUBJECT THROUGH THE CREATION OF A NON-COUNTERFEITABLE DIGITAL CERTIFICATE ADAPTED TO CERTIFY OWNERSHIP OR POSSESSION, USAGE AND MAINTENANCE OF THE ASSET

(71) Applicant: C.R.F. SOCIETA' CONSORTILE PER AZIONI, Orbassano (Torino) (IT)

(72) Inventors: Danilo GALGANI, Orbassano (Torino) (IT); Nicola CIANCI, Torino (IT)

(21) Appl. No.: 19/108,833

(22) PCT Filed: Sep. 7, 2023
(86) PCT No.: PCT/IB2023/058847

§ 371 Date: Mar. 5, 2025

(30) Foreign Application Priority Data
Sep. 9, 2022 (IT) 102022000018378

(51) Int. Cl. H04L 9/32; G06Q 40/04; H04L 9/00

(52) U.S. Cl. CPC H04L 9/3263; G06Q 40/055; H04L 9/50; G06Q 2220/00; H04L 2209/56

(57) ABSTRACT

A computer-implemented method and a system for recording data relating to a tangible asset (V) in association with a subject (U) are described, which are based on acquiring (120) data related to the asset (V) from a central asset management entity (S) adapted to store asset-related data comprising at least one unique asset identifier data and at least one among asset ownership or possession data, asset usage data, asset maintenance data, asset biographical data; on generating (140) a digital certificate associated with the asset; on storing (160) the digital certificate in a non-indexed way in at least one storage resource accessible in a public access communication network (W) via a respective unique identifier associated with the digital certificate; and on creating (220), in the digital register, a non-fungible token, NFT, including the unique identifier associated with the digital certificate, by means of the private key of a pair of cryptographic keys adapted to define the identity of the subject (U) in a blockchain digital register (B) replicated in a plurality of nodes of a computer network.

The present invention concerns non-counterfeitable certification technologies on distributed registers. More specifically, it concerns a computer-implemented method and a system for recording data relating to a tangible asset in association with a subject.

The invention is used in particular in the certification of usage and maintenance data of tangible assets.

Paper certificates, still widely used today, are not an effective method to guarantee the authenticity of an asset, its origin and its traceability. They are easily falsifiable, can be tampered with, replaced or combined with assets other than the one of origin.

Many complex assets, such as for example motorcycles, cars and the like, can be subject to maintenance and repair operations. The latter may be due to the need to repair an accidental damage (for example in the case of vehicles, damage caused by an accident), or linked to the misuse of the object itself. Other interventions, such as the replacement of a component that is defective, or has been incorrectly mounted during production, also fall within the category of extraordinary repairs or maintenances.

The value of a complex asset (i.e. consisting of several parts) of this type can be seriously affected in the event of maintenance or repair interventions being carried out not in a workmanlike manner, by unauthorized personnel and/or using non-original spare parts. The control of the authenticity of the spare parts and/or the correct performance of any intervention on the asset is a critical aspect in order to maintain its value over time.

To date, there are no digital or physical tools that efficiently guarantee, to a purchaser who succeeds a previous owner of the asset, that the asset he or she is buying has been correctly and legitimately subjected to all the periodic checks prescribed and provided for by the manufacturer and/or that it has been subjected to maintenance and/or repair operations with the use of only original spare parts or materials or in any case certified ones, for example by the production company, and carried out by competent personnel, authorized to perform them.

Nor are there methods and systems that allow a purchaser to ascertain the legitimate origin of the asset. This is true both in the case of the first purchase of a new asset, and even more so in the case of the purchase of an asset by a private individual or by a company, for example a leasing or rental company in the case of assets such as vehicles.

In essence, to date there are no tools available that allow an efficient and safe traceability of the asset and to date there is no centralized register or platform in which information relating to a specific asset is recorded, describing its history in order to preserve its value over time and to guarantee its origin and authenticity, for example in the case of subsequent transfers of ownership.

There is therefore a need to provide a method that allows to overcome in whole or in part the limits of the current systems of certification and guarantee of origin, authenticity and other aspects that affect the value of a tangible asset, that is, of a physical asset.

With the invention of the blockchains, smart contracts and NFTs it is now possible to attribute ownership of a digital content to the holder of a digital identity in blockchain, i.e. the holder of a digital wallet for cryptocurrencies.

The present invention is therefore intended to provide a satisfactory solution to the problems set forth above, avoiding the drawbacks of the prior art.

According to the present invention this object is achieved thanks to a method for recording data relating to a tangible asset in association with a subject, owner or user of the asset, having the characteristics referred to in claim 1.

Particular embodiments are the subject of the dependent claims, the content of which is to be understood as an integral part of the present description.

The invention further relates to a system for recording data relating to a tangible asset in association with a subject, owner or user of the asset, having the characteristics referred to in claim 14.

In summary, the present invention is based on the principle of certifying data relating to an asset, such as at least one unique identifier data of the asset and for example data for usage or maintenance of the asset, and notarizing the certification, i.e. guaranteeing the non-modifiability of the certification, through the issuance of a non-fungible token, NFT, assigned to the owner or user of the asset and transferable by them to third parties, at the time of the sale of the asset.

Specifically, a method is proposed for:
associating a digital identity on blockchain with the holder of a tangible asset, preferably, but not exclusively, a connected smart asset;
associating with said asset, a digital certificate, preferably, but not exclusively in the form of a graphic image comprising a graphic model of the certificate on which a series of information regularly collected by the asset itself and/or by other reliable sources (for example an authorized service centre) and stored at a management entity or trusted service centre at which the owner of the asset is recorded are superimposed;
preserving, if necessary, the privacy of the digital certificate by using asymmetric encryption and the storage of information in the deep web;
notarizing the certificate by issuing a non-fungible token, NFT; and
managing the transfer of ownership and the authorization to access information in a peer-to-peer manner at the time of the change of ownership of the asset.

Specifically, the non-fungible token does not directly include the digital certificate, but a link thereto, which is instead stored in at least one storage resource accessible in a public access communication network, preferably in a non-indexed way, through a respective unique identifier associated with the digital certificate.

Further characteristics and advantages of the invention will be explained in more detail in the following detailed description of an embodiment thereof, given by way of non-limiting example, with reference to the accompanying drawings, in which:

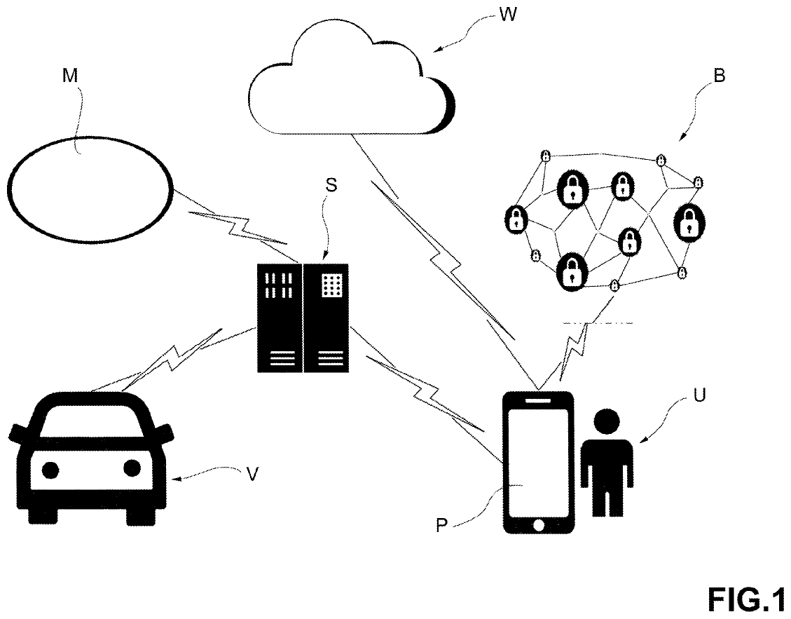

FIG. 1 is a schematic representation of the architecture of the system of the invention;

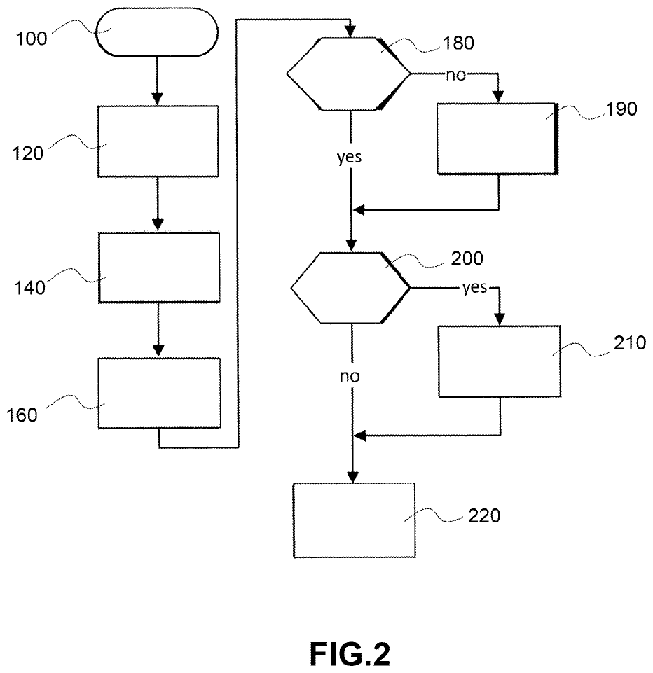

FIG. 2 is a flowchart of a process of creating a digital certificate and notarizing it in blockchain by issuing a non-fungible token, NFT, in the method for recording data relating to a tangible asset in association with a subject according to the invention; and

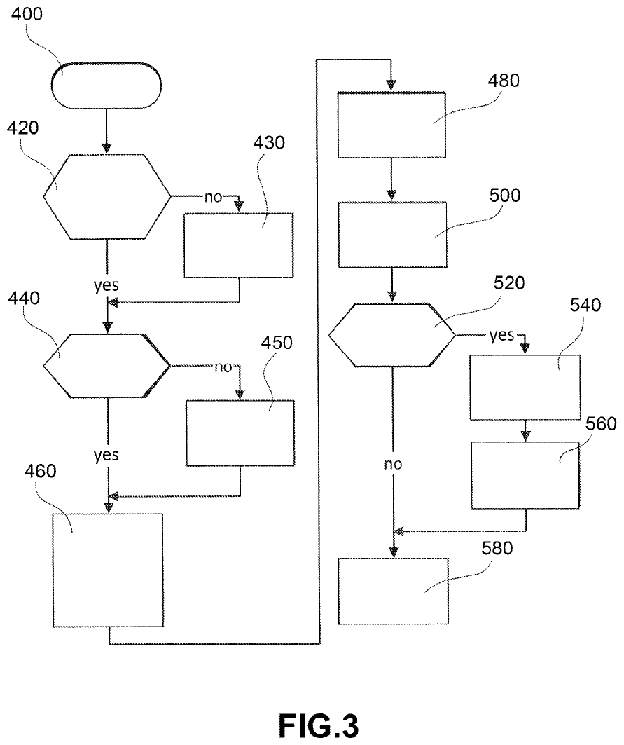

FIG. 3 is a flowchart of a process of transferring the privilege of access to the certificate and of notarizing on blockchain the transfer of ownership of the asset, for updating and transferring the non-fungible token, NFT, in the method for recording data relating to a tangible asset in association with a subject according to the invention.

A system for recording data relating to a tangible asset V in association with a subject U according to the invention comprises in combination:
a central asset management entity S adapted to generate data relating to the asset;
at least one storage resource in a public access communication network W;
a blockchain digital register B replicated in a plurality of nodes of a computer network; and
electronic processing means accessible to said subject, for example a personal electronic mobile communication device P of the subject, programmed to execute a computer application implementing a digital wallet for cryptocurrencies.

The subject U, or user, is the purchaser of the asset who has signed a contract for the provision of services associated with the asset itself.

The tangible asset is in the example a vehicle, preferably set up to communicate data relating to its usage, periodically or following events, with said central management entity S, for example through direct access to a telecommunication network (via telephone SIM) or indirectly via a connection gateway.

The system optionally comprises at least one entity M authorized to asset maintenance set up to communicate asset usage data or asset maintenance data, indicative of the maintenance operations carried out on the asset, to the central management entity S.

The central management entity S includes a (trusted) server for storing data relating to the asset, for example data generated by the manufacturer of the asset, said server possibly being set up for communication with the asset V (for example, to collect information on the usage of the asset directly from the asset) and with the entity M authorized to asset maintenance. More specifically, the central management entity S is adapted to store data relating to the asset comprising at least one unique identifier data of the asset such as the chassis number of the vehicle and at least once among asset ownership or possession data, asset usage data, asset maintenance data.

At least one storage resource W in a public access communication network is a server of a network node that ensures the persistence of information in the network by making it accessible through an identifier or two-way link generated at the time of storage, not associated with the asset or its holder, in a non-indexed way, and is generally referred to as a deep web resource. The deep web is that part of the World Wide Web not indexed by common search engines. This category includes new sites not yet indexed, web pages with dynamic content, web software and private corporate sites. A document in the deep web is only accessible to those possessing the link. Preferably, the non-indexed storage of the digital certificate takes place in at least one storage resource accessible in a public access communication network via the IPFs protocol.

The digital register B is a blockchain, such as Ethereum or another network compliant with EVM (Ethereum Virtual Machine). Blockchain technologies are included in the broader family of Distributed Ledger Technologies (DLTs)—systems that rely on a distributed register, which can be read and modified from multiple nodes in a network. To validate the changes to be made to the register, in the absence of a central entity, the nodes must reach the consent. The manners with which consent is reached and the structure of the register are some of the characteristics that characterize the different Distributed Ledger technologies. The blockchain is therefore a subset of the DLT technologies, in which the register is structured as a chain of blocks containing the records and the consent is distributed over all nodes of the network that can participate in the process of validating the information to be included in the register.

As is known, the users of a blockchain are identified through “addresses” derived from the public key of a pair of cryptographic keys adapted to define the digital identity of a user, here the subject U, in blockchain, that is a digital wallet for cryptocurrencies. The users of a blockchain, in possession of a digital wallet for cryptocurrencies, can interact with each other to exchange the primary currency of the blockchain or by means of smart contracts to which their digital assets are entrusted and which can create new ones through the issuance process (or minting) in the form of virtual tokens transferable among users.

A smart contract is a program that is executed on a blockchain or, more generally on a DLT network, operating according to strict rules when specific events occur. Through a smart contract two or more parties can reach an agreement even without knowing each other directly, wherein the nodes of the computer network are the “guarantors” of compliance with the “reached agreements” defined in the smart contract according to IFTTT reports (if . . . , then . . . ).

A virtual token is a digital asset that is created according to known standards (often different on different blockchains) that are encoded in the form of smart contracts loaded and then executed on a network of computers. They are assigned to one or more users (typically, the user who recorded the relative smart contract on the network) and can be transferred among users, based on the rules written in the smart contract itself.

Among the virtual tokens, the non-fungible tokens, NFTs, are special tokens that represent unique assets, unlike the classic tokens that, issued in multiplicity, are indistinguishable from one another.

Most of the NFTs in circulation today were created on the Ethereum platform and follow the ERC-721 standard thus ensuring clear rules for the transfer among users and the use on different applications. For each smart contract representing a family of NFTs in the ERC-721 standard there are defined properties, which include Name, Symbol, TokenID, and to enrich the content associated with an NFT to them a TokenURI, that is a document in JSON format that defines a set of metadata (Name, Description, image URI) and is extensible, and an extension to verify the property (the address where it is stored) of the individual NFT are almost always added.

The method of the invention for recording data relating to a tangible asset V in association with a subject or user U, owner or user of the asset, comprises in combination:
generating a pair of cryptographic keys, a public key and a private key respectively, adapted to define the identity of the subject U in the digital register B;
acquiring data relating to the asset from the central asset management entity S; generating a digital certificate associated with the asset;
storing the digital certificate in a non-indexed way in at least one storage resource W; and
creating, in the digital register B, a non-fungible token, NFT, including the unique identifier associated with the digital certificate, by means of the private key of the pair of cryptographic keys that define the identity of the subject U.

The method is performed by a computer application accessible to the subject U, residing on, or accessible from, a personal electronic mobile communication device P of the subject, which implements a digital wallet for cryptocurrencies, and the pair of cryptographic keys is stored in said wallet.

Preferably, the non-fungible token, NFT, includes the unique identifier associated with the digital certificate in encrypted form, for example subjected to asymmetric key encryption by means of the public key of the pair of cryptographic keys adapted to define the identity of the subject U in the digital register B.

By way of example, the digital certificate comprises a digital image made by superimposing the acquired data, related to the asset, on a predetermined graphic model or pattern of representation of said data.

By means of the method of the invention, the owner of an asset, for example a vehicle, by signing a specific contract, can be recorded for the provision of value-added services including the one described herein useful for creating digital certificates (attesting to the usage and maintenance information of the vehicle collected by the service centre or acquired through the integrated connectivity from the asset itself and from the service centres authorized for its maintenance), which are stored in the deep web and notarized in blockchain through the creation of an NFT.

The proposed method envisages the interaction of the user with an application on a smartphone capable of interacting with different players: the service centre, a cloud storage system in the deep web and a blockchain.

In detail, the method provides that, through the use of the application, the user can:
create his or her own digital identity in blockchain (through the generation of a private key) which, protected by a specific password, can be used to sign the requests for actions on the blockchain according to the rules of the blockchain that one chooses to use;
require the creation of a usage and maintenance certificate (stored in the deep web) and, consequently, its notarization on the blockchain, i.e. the certification of the date of creation or update of the certificate and the fact that it has not undergone any variation; and
transfer in a protected way (or not) the link useful to access the certificate, by notarizing the event on the blockchain, in case of asset transfer.

With reference to the flowchart of FIG. 2, a process for creating a digital certificate of ownership, usage and maintenance of an asset, and the notarization thereof in blockchain by issuing an NFT are described.

Conditions for the implementation of the process are that the user U, owner of the asset, has signed a contract for the provision of services (free or paid) associated with the asset itself, that the user has a personal electronic mobile communication device, for example a smartphone, compatible with the application provided by the person providing the services and that said application is installed on the device, that the asset has been uniquely associated with the user through an appropriate process that goes beyond the method described herein.

In step 100 the process begins and the user U selects in the application executed on the device P the option of generating the digital certificate.

In step 120, the usage and maintenance data are extracted from the service centre and included in an image that represents a certificate of ownership, usage and maintenance of the asset in step 140.

The image is saved in the deep web in step 160 and becomes addressable through a link with the characteristic of being unique, guaranteeing the impossibility of associating different images with the same link at later times.

Upon request to create the certificate, in step 180 it is verified whether the user has a digital wallet and, in the negative case, in step 190 the application starts a wizard for the creation of a pair of keys (public and private) that define the identity of the user on the blockchain and will allow him or her to create, send and receive tokens on the blockchain itself. The application is thus ready to operate as a digital wallet, capable of storing and transferring assets on the blockchain.

In case the link (or unique identifier) of the digital certificate is saved in encrypted form, if this is selected in step 200, the process implements in step 210 the asymmetric key encryption of the link using the public key of the previously created digital wallet, effectively making the information accessible only to the user entitled to create the NFT.

Finally, in step 220, thanks to the use of the private key, the application requests the creation of the non-fungible token, NFT, which contains in encrypted form the link to the digital certificate previously generated.

With reference to the flowchart of FIG. 3, a process of transferring the privilege of access to the digital certificate and notarizing the transfer of ownership and access rights on the blockchain, for updating and transferring the NFT is described.

Conditions for the implementation of the process are that the user holding an asset intends to transfer the asset by transferring the relative digital certificate of ownership, usage and maintenance, and that the recipient of the asset (not depicted) is recorded with the asset central management entity and has a personal electronic mobile communication device, for example a smartphone, compatible with the application provided by the service provider and that said application is installed on the device, allowing in the first instance the access of the purchasing subject in guest mode.

In summary, transferring the digital certificate from a first transferring subject to a second purchasing subject, whose identity in the digital register B is defined by a relative pair of cryptographic keys, a public key and a private key respectively, comprises transferring the non-fungible token including the unique identifier associated with the digital certificate from a digital wallet for cryptocurrencies accessible to the first subject to a digital wallet for cryptocurrencies accessible to the second subject.

This is done by communicating to the first subject the public key of the second subject, decrypting the unique identifier associated with the digital certificate included in the non-fungible token, NFT, by means of the private key of the pair of cryptographic keys adapted to define the identity of the first subject in the digital register, and subsequently encrypting the unique identifier associated with the digital certificate by means of the public key of the pair of cryptographic keys adapted to define the identity of the second subject in the digital register. Finally, the unique identifier associated with the digital certificate, encrypted by means of the public key of the second subject, is associated with its non-fungible token, NFT.

According to a currently preferred embodiment, communicating to the first subject the public key of the second subject comprises displaying an identification code of the public key of the second subject stored in a digital wallet for cryptocurrencies accessible to the second subject, e.g. a QR code, and reading said identification code and acquiring the public key of the second subject by the digital wallet for cryptocurrencies accessible to the first subject.

FIG. 3 shows the sequence of the events.

The process begins in step 400 and, in the case of a purchasing subject that is not recorded at the service centre, after verification in step 420, provides for recording at the service centre the purchasing subject in guest mode, in step 430.

In step 440 it is verified whether the purchasing subject has a digital wallet in the blockchain B and in the negative case, in step 450 a digital wallet for cryptocurrencies is created in the name of the second subject, according to the procedure of creation of known digital identity described with reference to the subject that owns the asset.

In step 460 the purchasing subject activates, from the environment of his or her application, the NFT receiving function and the public key of the associated wallet is displayed on the device display, for example in the form of a QR code.

In step 480, the selling subject frames the QR code through his or her application, capturing the public key that will be used to recode the link to the image of the certificate to be transferred stored in the cloud W.

In step 500 the selling subject authorizes the transfer of the link of the certificate to the wallet of the purchasing subject, in step 520 it is verified whether this link is encrypted and, in the affirmative case, in step 540 the link is decoded with the private key of the selling subject and subsequently encoded with the public key of the purchasing subject.

In step 560 the new encrypted link is associated with the NFT present on the wallet through an operation of updating the same.

Finally, in step 580, the NFT, no longer decodable by the selling subject, is transferred on the digital wallet of the purchasing subject thus allowing said subject to have access to the image of the certificate.

Note that the embodiment proposed for the present invention in the foregoing discussion is purely exemplary and not limiting the present invention. A person skilled in the art can easily implement the present invention in different embodiments that do not deviate from the principles set forth herein, and are therefore included in the present patent.

This applies in particular to what concerns the possibility of applying the method and the system of the invention to tangible assets of another type than vehicles, including assets that are not objects, but living beings, for example pets, of which it is intended to certify the related property data and biographical data.

Finally, the invention also relates to a computer program, in particular a computer program on or in an information medium or memory, adapted to implement the invention. This program may use any programming language, and be in the form of source code, object code, or executable code, or in any other form desired to implement a method according to the invention. The information medium may be any entity or device capable of storing the program or a transmissible medium, such as an electrical or optical signal, which may be transmitted through wired electrical or optical connections, through radio signals, or by other means. The program according to the invention may in particular be downloaded from an Internet-type network onto a personal electronic mobile communication device such as a smartphone.

Of course, without prejudice to the principle of the invention, the forms of implementation and the details of construction can vary widely with respect to what has been described and illustrated purely by way of non-limiting example, without departing from the scope of protection of the invention defined by the appended claims.

We claim:

1-15. (canceled)

16. A computer-implemented method for recording data relating to a tangible asset in association with a subject, characterized by comprising in combination:
generating a pair of cryptographic keys, a public key and a private key, respectively, adapted to define the identity of said subject in a concatenated block digital register replicated in a plurality of nodes of a computer network;
acquiring data related to the asset from a central asset management entity adapted to store asset-related data comprising at least one unique asset identifier data and at least one among asset ownership or possession data, asset usage data, asset maintenance data, and asset biographical data;
generating a digital certificate associated with said asset;
storing said digital certificate in a non-indexed way in at least one storage resource accessible in a public access communication network via a respective unique identifier associated with said digital certificate; and
creating, in said digital register, a non-fungible token, NFT, including said unique identifier associated with the digital certificate, by means of the private key of said pair of cryptographic keys adapted to define the identity of the subject in the digital register.

17. The method of claim 16, wherein said digital certificate comprises an image made by superimposing said acquired data related to the asset on a predetermined graphic model or pattern for data representation.

18. The method of claim 16, characterized in that it is performed by a computer application accessible to said subject, which implements a digital wallet for cryptocurrencies and said pair of cryptographic keys is stored in said wallet.

19. The method of claim 18, wherein said computer application accessible to said subject is a computer application residing on, or accessible from, a personal electronic mobile communication device of the subject.

20. The method of claim 16, wherein said tangible asset is a tangible asset arranged for communicating data with said central management entity.

21. The method of claim 16, wherein at least one entity authorized to maintain the asset is arranged for communicating asset usage data or asset maintenance data to said central management entity.

22. The method of claim 16, wherein the non-indexed storage of said digital certificate takes place in at least one storage resource accessible in a public access communication network through the IPFS protocol.

23. The method of claim 16, wherein said subject is registered with said central asset management entity.

24. The method of claim 16, wherein said non-fungible token, NFT, includes said unique identifier associated with the digital certificate in encrypted form.

25. The method of claim 24, wherein said unique identifier associated with digital certificate is encrypted with asymmetric key encryption by means of the public key of said pair of cryptographic keys adapted to define the identity of the subject in the digital register.

26. The method of claim 25, comprising transferring said digital certificate from a first subject to a second subject whose identity in the aforesaid digital register is defined by a corresponding pair of cryptographic keys, a public key and a private key respectively, comprising transferring said non-fungible token including said unique identifier associated with the digital certificate from a digital wallet for cryptocurrencies accessible to the first subject to a digital wallet for cryptocurrencies accessible to the second subject, characterized in that it further comprises:
communicating to said first subject the public key of the second subject;
decrypting said unique identifier associated with the digital certificate included in said non-fungible token, NFT, by means of the private key of said pair of cryptographic keys adapted to define the identity of the first subject in the digital register, and subsequently encrypting said unique identifier associated with the digital certificate by means of the public key of said pair of cryptographic keys adapted to define the identity of the second subject in the digital register; and
associating said unique identifier associated with the digital certificate, encrypted by means of the public key of the second subject, with said non-fungible token, NFT.

27. The method of claim 26, wherein said communicating to the first subject the public key of the second subject comprises:
displaying an identification code of said public key of the second subject stored in a digital wallet for cryptocurrencies accessible to the second subject; and
reading said identification code and acquiring said public key of the second subject by the digital wallet for cryptocurrencies accessible to the first subject.

28. The method of claim 26, wherein said second subject is registered with said central asset management entity.

29. A system for recording data relating to a tangible asset in association with a subject, characterized by comprising in combination:
a central asset management entity adapted to generate data relating to the asset;
at least one storage resource in a public access communication network;
a concatenated block digital register replicated in a plurality of nodes of a computer network; and
electronic processing means accessible to said subject, programmed to execute a computer application implementing a digital wallet for cryptocurrencies, adapted to carry out the method of claim 1.

30. A computer program or group of programs executable by electronic processing means, comprising one or more code modules for the implementation of a method for recording data relating to a tangible asset in association with a subject according to claim 1.
